(19) United States
(12) Patent Application Publication
(10) Pub. No.: US 2016/0218547 A1
(43) Pub. Date: Jul. 28, 2016

(54) MONOPOD FOR WIRELESSLY POWERING AND USING OF ELECTRICAL ACCESSORIES

(71) Applicant: Christian L. Corley, Olathe, KS (US)

(72) Inventor: Christian L. Corley, Olathe, KS (US)

(21) Appl. No.: 14/716,600

(22) Filed: May 19, 2015

Related U.S. Application Data
(63) Continuation-in-part of application No. 14/660,626, filed on Mar. 17, 2015.
(60) Provisional application No. 62/108,136, filed on Jan. 27, 2015.
(60) Provisional application No. 62/107,704, filed on Jan. 26, 2015.

(51) Int. Cl. H02J 7/02; F16M 11/04; G03B 17/56; H02J 7/00; B63B 17/00; B63B 49/00; F16M 13/02; H01R 24/60

(52) U.S. Cl. CPC H02J 7/025; F16M 13/022; F16M 11/04; H01R 24/60; H02J 7/0045; B63B 17/00; B63B 49/00; G03B 17/561

(57) ABSTRACT

A monopod for mounting to the navigation light power port of a marine vessel, such as a bass boat or speed boat, which provides power for mobile accessories, such as cameras and smart phones. The monopod may be fitted with extendable, bendable arms for mounting additional cameras or for providing additional accessories. An embodiment of the monopod includes an extension arm which may be maneuvered and bent such that it provides a fisherman access to multiple accessories even while the fisherman is located in the fishing chair of a bass boat.

### CROSS-REFERENCE TO RELATED APPLICATIONS

This application is a continuation-in-part of and claims priority in U.S. patent application Ser. No. 14/660,626, filed Mar. 17, 2015, which claims priority in U.S. Provisional Patent Application No. 62/108,136, filed Jan. 27, 2015, and also claims priority in U.S. Provisional Patent Application No. 62/107,704, filed Jan. 26, 2015, all of which are incorporated herein by reference.

### BACKGROUND OF THE INVENTION

1. Field of the Invention

The present invention relates generally to a monopod marine vessel accessory, and more specifically to a monopod which connects with the navigation light socket port(s) of a marine vessel and may provide power to mobile accessories.

2. Description of the Related Art

Many boating enthusiasts, from professional bass fisherman such as Casey Scanlon, to extreme water sport performers, desire to record their sporting feats using cameras such as GoPro® cameras manufactured by GoPro, Inc. of San Mateo, Calif. and other action cameras, including but not limited to the Garmin Virb®, manufactured by Garmin Ltd. of Olathe, Kans., and the iON™ action camera, manufactured by iON America, LLC of Moorestown, N.J. Other more casual boating enthusiasts, such as Roger Corley, may wish to similarly record family activities, charge mobile computing devices, or otherwise provide power to accessories or method of attachment for accessories while on a marine vessel.

Presently there are capabilities of providing power to mobile accessories using 12V ports (a.k.a. cigarette lighters). However, many boats, and certainly most older boats, lack such a power port. Similarly, when that power port exists in a boat, it typically is located near the steering column and not near the rear and/or front of the boat where activity generally occurs.

What is needed is a power solution for mobile devices, including smart phones, cameras, and other electronic devices consumers may want aboard, which is compatible for mounting non-electronic accessories also, and further which is compatible with virtually all marine vessels, which offers flexibility and versatility for multiple water sports and activities.

Heretofore there has not been available a monopod for marine vessels with the advantages and features of the present invention.

### SUMMARY OF THE INVENTION

The present invention generally provides a monopod for mounting to the navigation light power port of a marine vessel, such as a bass boat or speed boat, which provides power for mobile accessories, such as cameras and smart phones. The monopod may be fitted with extendable, bendable arms for mounting additional cameras or other electronic devices or for providing additional accessories.

### BRIEF DESCRIPTION OF THE DRAWINGS

The drawings constitute a part of this specification and include exemplary embodiments of the present invention illustrating various objects and features thereof

FIG. 1 is an isometric view of an embodiment of the present invention located in a typical environment in which it may be deployed, herein depicted as a bass fishing boat.

FIG. 2 is a detailed isometric view thereof, taken about the circle on FIG. 1.

FIG. 3A is an isometric view from the base of an embodiment of the present invention.

FIG. 3B is an isometric view from the top thereof

FIG. 4 is a front elevational view of an alternative embodiment thereof

FIG. 5 is an isometric view of another embodiment of the present invention.

FIG. 6 is an isometric view of yet another embodiment of the present invention.

FIG. 7 is an isometric view of yet another embodiment of the present invention.

FIG. 8 is an alternative isometric view thereof, showing a cup holder accessory.

FIG. 9 is an isometric view of the embodiment of FIG. 8 located in a typical environment in which it may be deployed, herein depicted as a bass fishing boat.

FIG. 10A is an isometric view from the base of yet another alternative embodiment of the present invention.

FIG. 10B is an isometric view from the top thereof

FIG. 11 is a bottom-up isometric view of an alternative embodiment of the present invention.

FIG. 12 is a top-down isometric view thereof.

FIG. 13 is an isometric view of elements thereof

FIG. 14 is an isometric view indicating the connection of elements thereof

FIG. 15A is a diagrammatic elevational view thereof, showing two elements being connected.

FIG. 15B is a diagrammatic elevational view thereof, wherein the two elements of FIG. 15A are connected.

### DETAILED DESCRIPTION OF THE PREFERRED EMBODIMENTS

I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate.

Additional examples including a mobile smart device including a display device for viewing a typical web browser or user interface will be commonly referred to throughout the following description. The type of device, computer, display, or user interface may vary when practicing an embodiment of the present invention. Said terminology will include the words specifically mentioned, derivatives thereof and words of similar meaning

Power providing inputs in the embodiment of the invention may encompass any format of Uniform Serial Bus (USB) input, 12V input, or any other type of power adapter. However, the embodiment of the present invention is intended only to be inserted into the navigation light port located on a marine vessel. The marine vessel applies to any type of boat, ship, or any other waterborne vessel which encompasses a navigation light port. A standard navigation light port is considered to be a port on a marine vessel which is required by the International Regulations for Preventing Collisions at Sea.

II. Preferred Embodiment Marine Monopod System 2

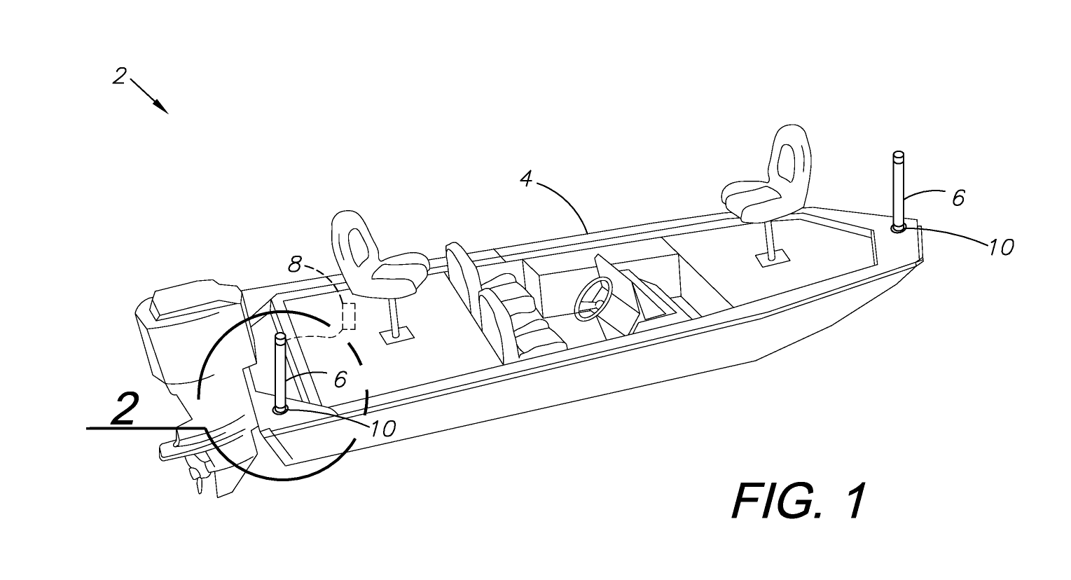

Referring to the figures in more detail, FIG. 1 shows a marine vessel 4 employing a marine monopod system 2. The monopod system 2 includes a monopod 6 which is inserted into a navigation light power port 10 and draws power from the port for electronic devices 8, such as smart phones, cameras, global positioning system (GPS) devices, and other mobile electronic devices. Note that a second navigation light power port 10 is located at the front of the vessel 4, which may accommodate a second monopod 6. Other ports may be located in other locations around the vessel.

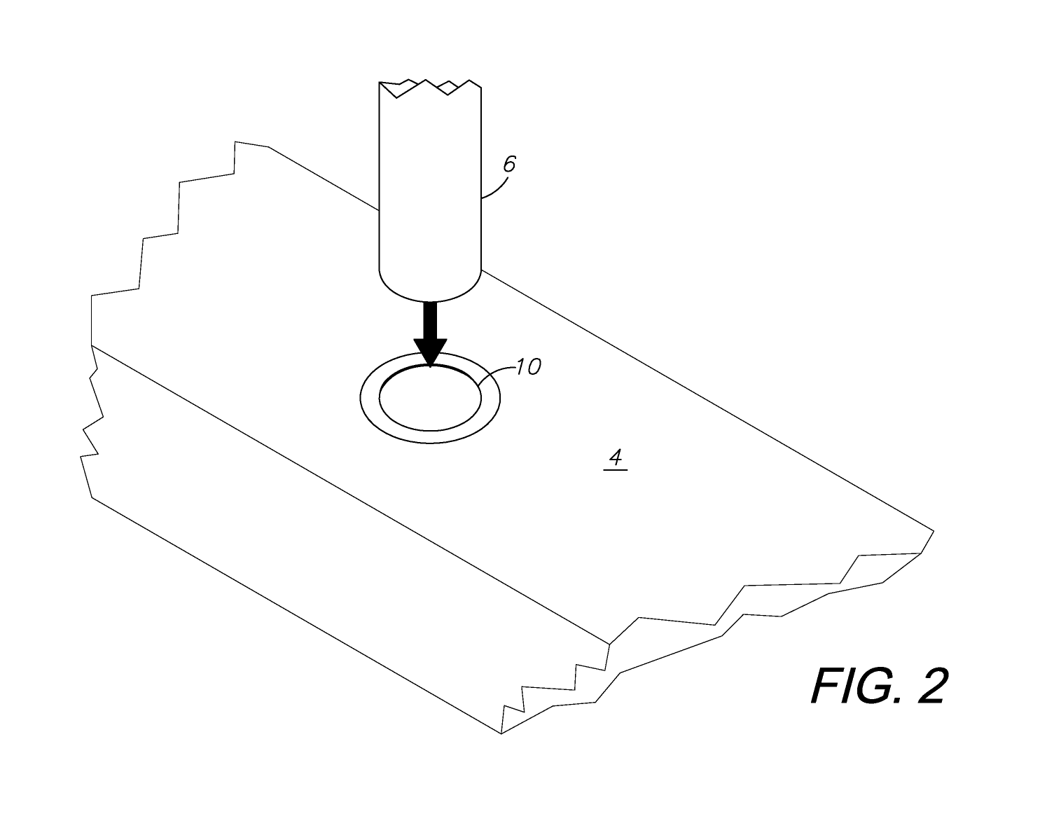

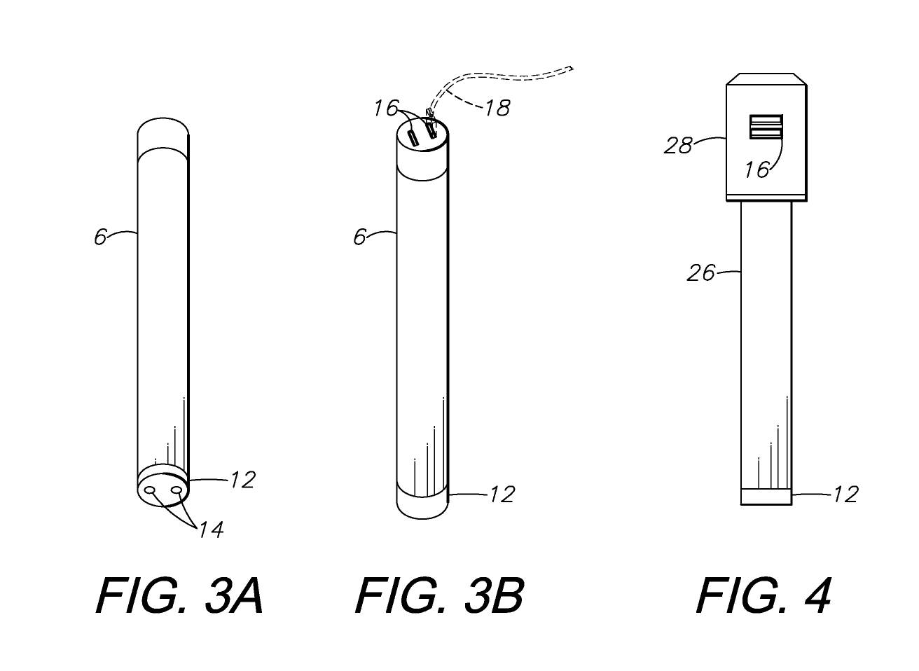

FIG. 2 shows a closer view of the monopod 6 being inserted into the power port 10. FIGS. 3A and 3B show more detail of the monopod 6. This embodiment includes a monopod base 12 with contacts 14 for drawing power from the power port 10. A pair of Universal Serial Bus (USB) ports 16 are shown on the top portion of the monopod. Cables 18 for charging mobile devices may be inserted into these ports, and power is drawn from the power port 10. Other types of power adapters, such as 12V adapters, may be used instead of USB ports.

FIG. 4 shows an alternative embodiment monopod 26 which includes a head portion 28 with the USB ports 16 mounted on one or more sides of the head portion.

III. Alternative Embodiment Marine Monopod System 52

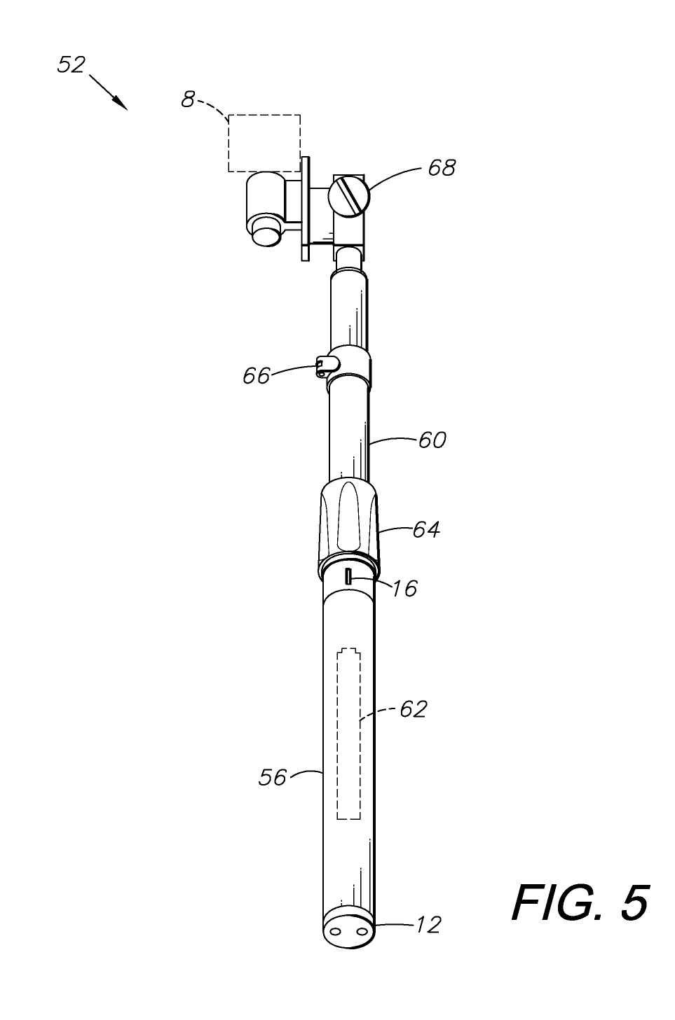

FIG. 5 shows an alternative marine monopod system 52 which uses a base monopod 56 with a telescoping arm 60 capable of extending a few inches or several feet above or away from the marine vessel. The monopod 56 includes the same base 12 for connecting with the navigation light port 10 and at least one USB port 16 for powering an accessory 8. Here, it is likely that the accessory is a camera for capturing video images, but the accessory could be any electronic device.

The telescoping arm 60 may be connected to the base monopod 56 with an adjustable handle 64 which tightens or loosens to allow telescoping of the arm 60. Other means may be employed which allow the arm to telescope. A second telescoping motion may be employed by releasing a locking device 66 at a second point along the arm 60. This locking device as shown can be quickly unlocked or locked using one finger.

The base monopod 56 may include a rechargeable battery 62, allowing the monopod to power or charge a device 8 even when it is not inserted into the navigational light port 10. An accessory mount 68, such as the screw-based camera mount shown here, may be connected to the top of the telescoping arm 60.

IV. Alternative Embodiment Monopod System 102

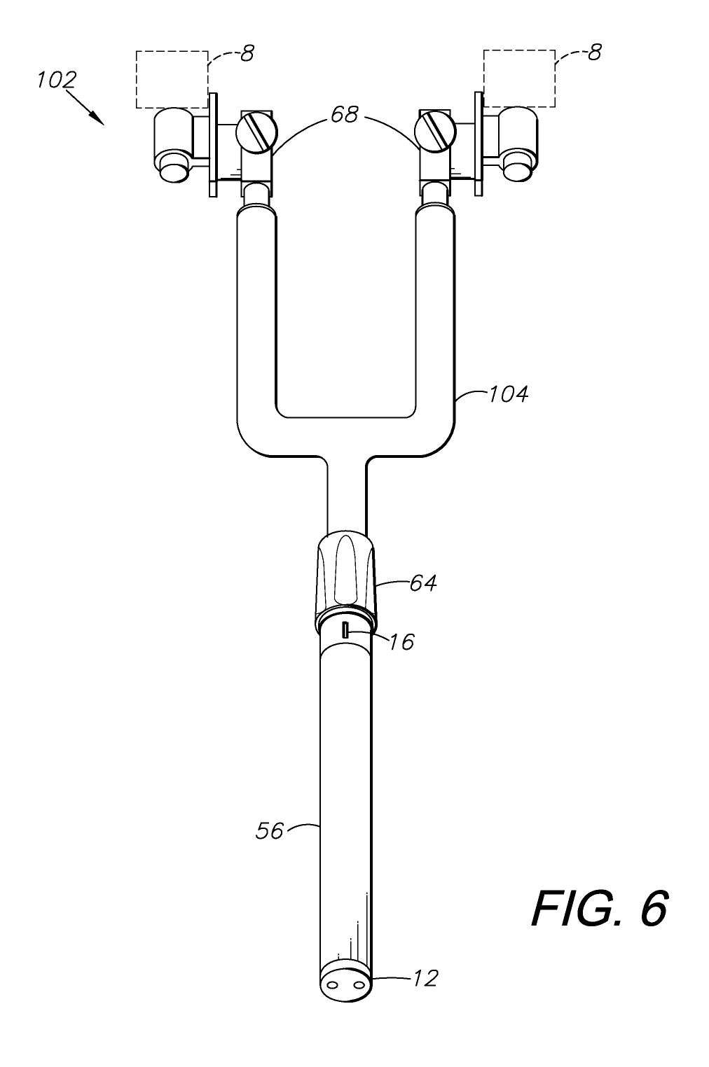

FIG. 6 employs many of the same features as the system 52 described above, but instead of the telescoping arm 60 of system 52, this system employs a forked arm 104 which is connected to the base monopod 56, and which allows for two devices to be connected to the same monopod system 102. In this way, one camera could face forward while the other faces away. Alternatively, two devices could charge simultaneously while being used.

V. Alternative Embodiment Monopod System 152

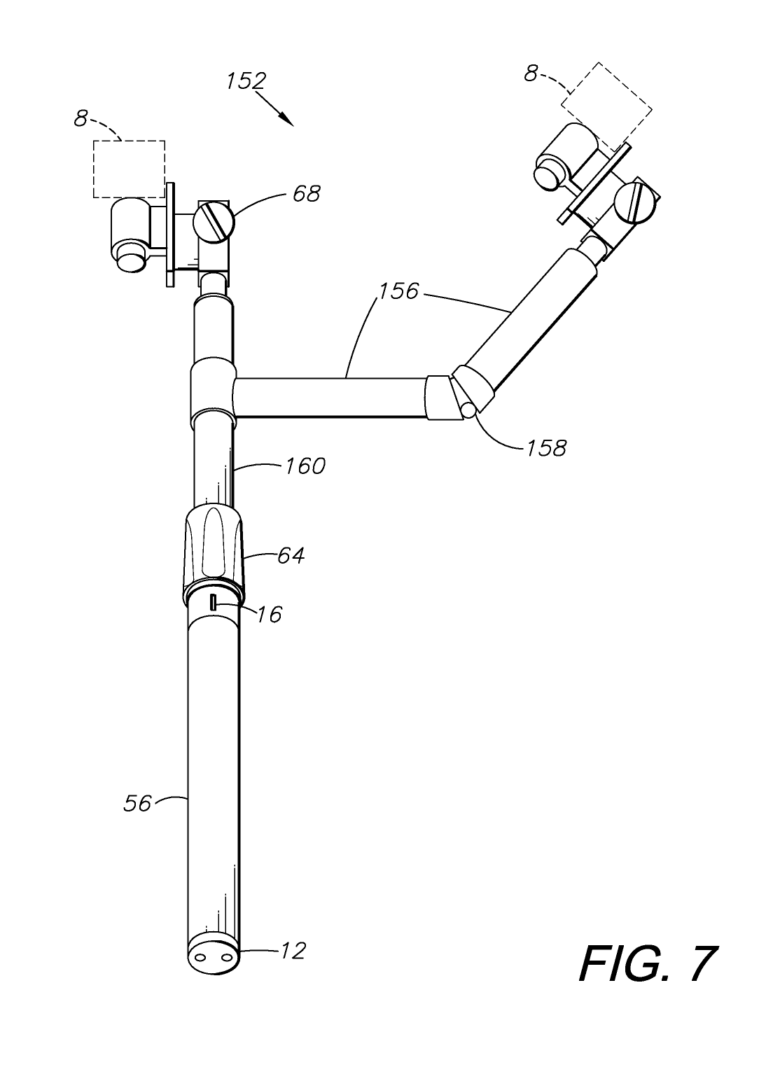

FIG. 7 shows an alternative embodiment monopod system 152 which uses the same base monopod 56 setup as systems 52 and 102, but which includes a telescoping arm 160 which allows an extension arm 156 to connect to the telescoping arm 160, either using a clip, a connecting ring, or some other connecting device. The extension arm 156 may culminate at an elbow 158, which may connect to a second extension arm 156 as shown. This type of connection could occur several times. It is important that the elbow 158 contain significant resistance against being bent such that the arms 156 retain any angle they are set at. This allows for dynamic camera angles using cameras as the electrical accessories. For example, in a boat, the extension arm 156 could place a camera close to the water as the boat moves through the water, while the other camera is placed far above the boat. The two cameras would capture video simultaneously.

Additional extension arms may be placed for two, three, four, or more camera angles.

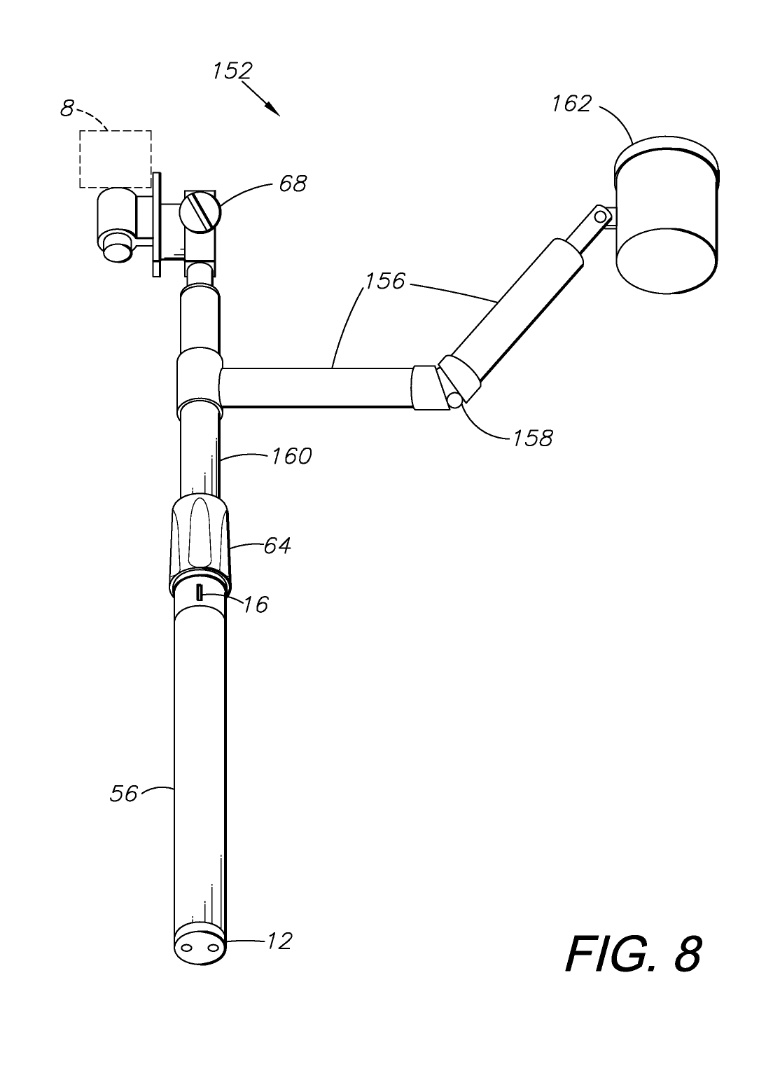

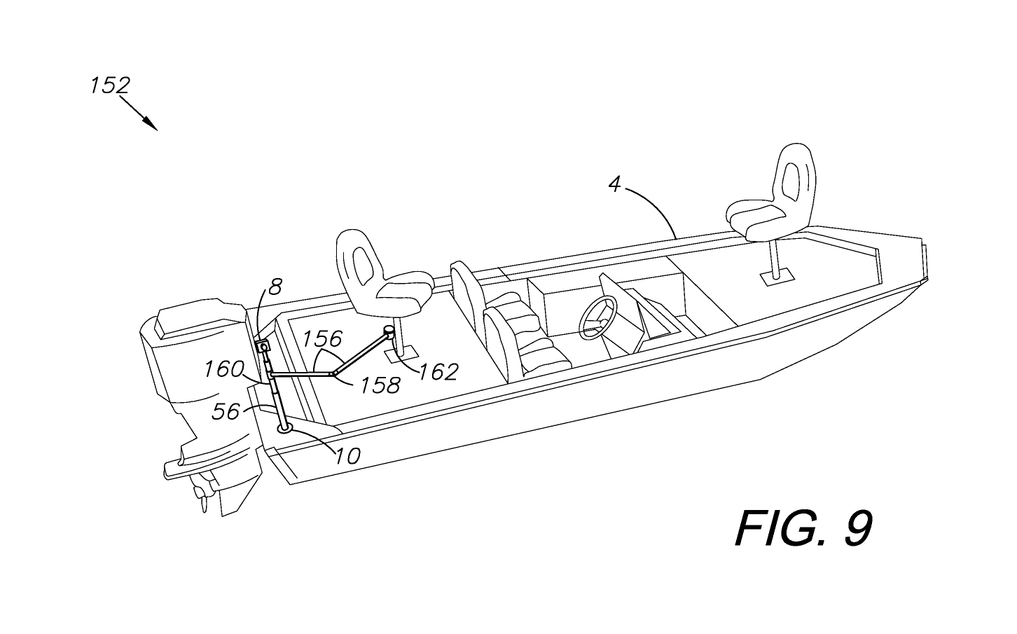

Alternatively, as shown in FIG. 8, the accessory may instead be a cup holder 162. It is common for bass fishing boats or older boats to lack sufficient space to store drinks, especially when a fisherman is in the fishing seat. FIG. 9 shows how the arm can be positioned to provide a cup holder to the fisherman while a camera is still filming from atop the telescoping arm 160.

VI. Alternative Embodiment Monopod System 202

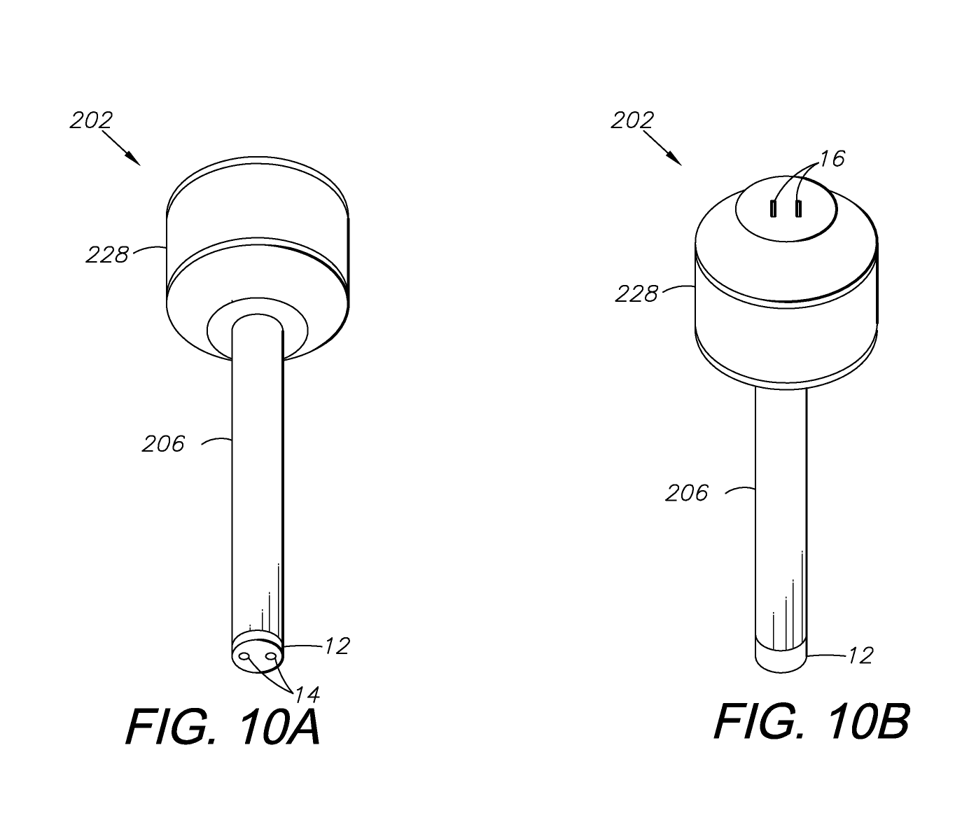

FIGS. 10A and 10B employ a monopod 206 which includes a basic navigational lamp 228 atop the monopod 206. As shown, two USB ports 16 are located atop the lamp. However, the USB ports could be placed along the sides of the monopod 206, and an accessory mount, such as those shown in FIGS. 5-8 above, may be placed atop the lamp. This would allow for a camera to be mounted to the navigational lamp and filming to take place even while the navigational light is in use or at night.

It should be noted that any and all commercial electronic devices could benefit from the present invention. GPS devices, fish finders, and tablet computers would be at the fisherman's fingertips using one or more of the embodiments of the present invention without the fisherman leaving the fishing chair.

VII. Wireless Power Source Monopod System 302

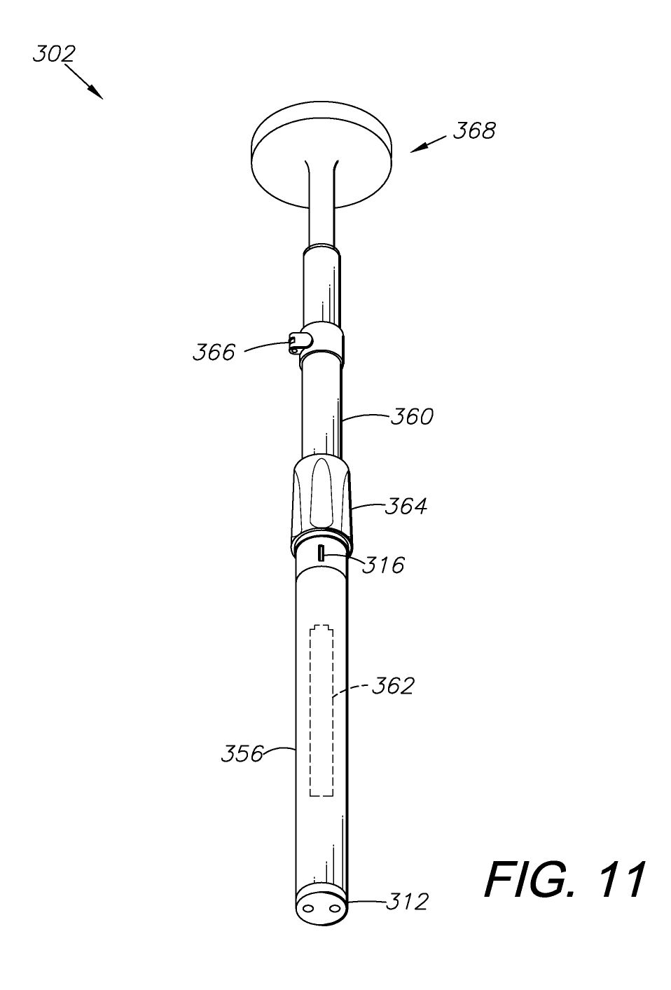

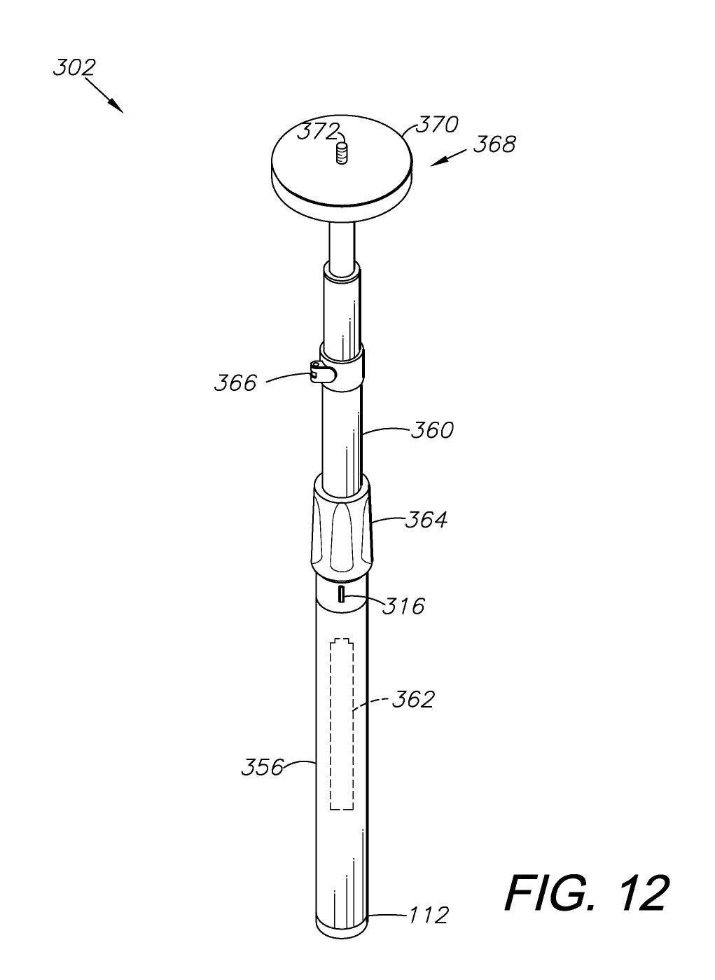

FIGS. 11-15B show another alternative embodiment system which includes wireless power for powering an electrical accessory, such as a camera as discussed above. As shown in FIGS. 11-12, a monopod 356 having a telescoping arm 360 includes a battery power source 362, a charging port 312 which may or may not interface with a navigation light port of a watercraft, and locking elements 366 for locking the telescoping arm 360 at various lengths. The monopod may or may not include a USB port 316 or other port for charging of electrical accessories. A preferred embodiment may include an adjustable handle 364 for extending and retracting the telescoping arm 360.

This embodiment also includes a wireless power delivery system 368 connected to the end of the telescoping arm 360. The primary features of this delivery system 368 are shown in FIG. 12 and include a base 370 and a mounting screw 372, such as typically used to mount cameras or camera cases to monopods or tripods.

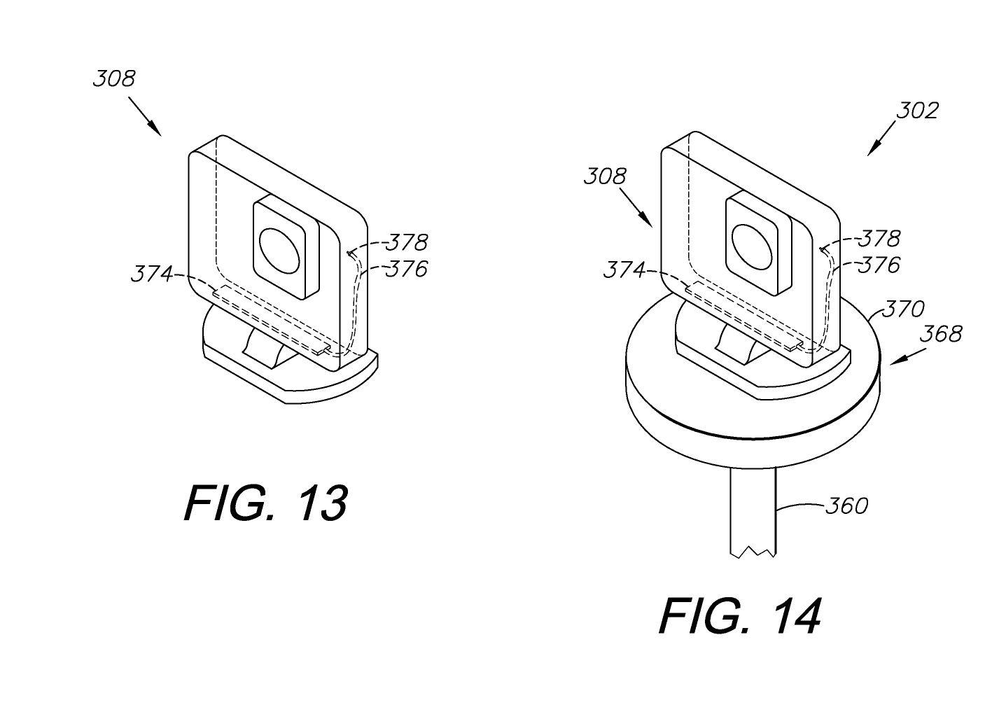

FIG. 13 shows a typical camera housing accessory 308 which would be used to house cameras, such as those disclosed above. The camera housing accessory 308 is designed to mount to the mounting screw 372 of the wireless power delivery system 368. A receiver strip 374 connects to the camera or other electrical accessory via a cord 376 and interface 378. FIG. 14 shows how the camera housing accessory 308 mounts to the base 370 of the wireless power delivery system. In a preferred embodiment the camera housing accessory 308 would be waterproof.

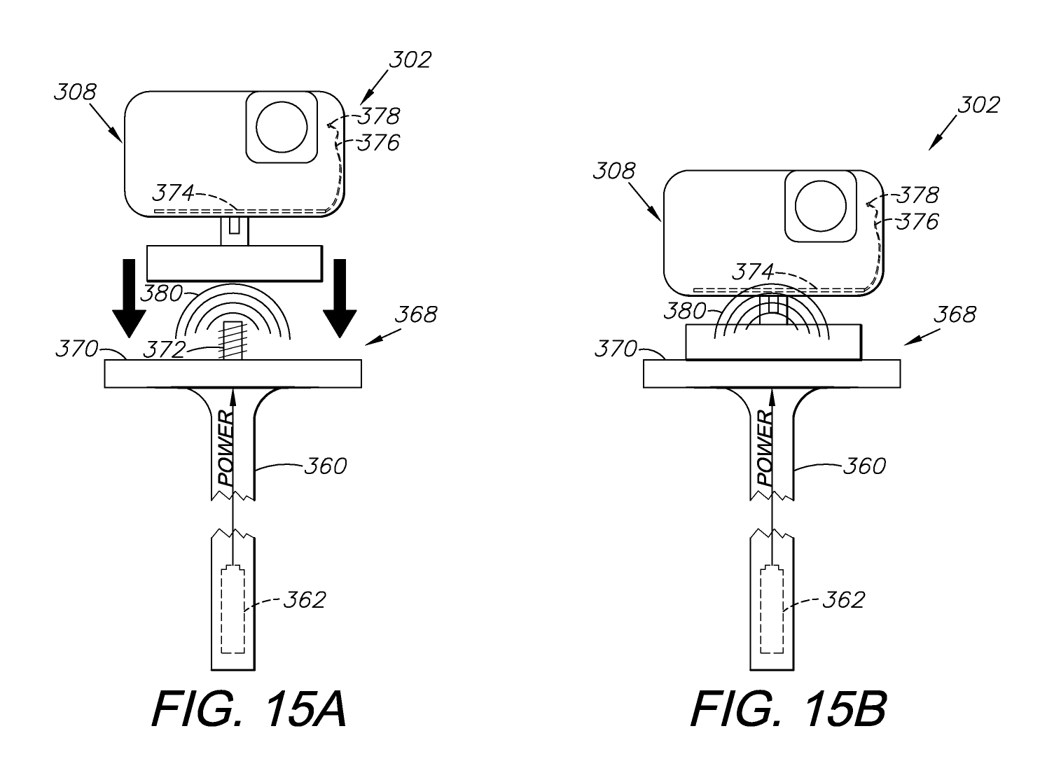

The wireless power delivery system 368 draws power from the battery source 362 of the monopod 356 as shown in FIG. 15A. The delivery system 368 delivers wireless power 380 in a limited range about the base 370, typically less than six inches from the base. As shown in FIG. 15B, when the accessory 308 is attached to the delivery system 368, the wireless power 380 is received by the receiver strip 374 and is delivered to the camera or other electrical accessory via the power cord 376 and interface 378. This wireless power then powers the electrical accessory when in use, and passively charges a battery associated with the electrical accessory, if any, when the accessory is not in use. It should be noted that any and all types of electrical accessories mentioned herein or otherwise requiring electrical power could utilize this arrangement of elements.

In an embodiment of this invention, an ergonomic handle may be located just beneath the wireless power delivery system 368, converting the monopod device into a walking or hiking stick.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A monopod for interfacing with an electrical accessory, the monopod comprising:
a cylindrical elongated body portion having a proximal end and a distal end, said body portion including a battery power source;
a housing for containing said electrical accessory;
a wireless power receiver comprising a strip and a power input for interfacing with a charging port of said electrical accessory, said receiver placed within said housing;
an accessory base located in proximity to the distal end of said body portion;
a wireless power transmitter located within said accessory base, said wireless power transmitter receiving power from said battery power source; and
said wireless power receiver configured to receive power from said wireless power transmitter and to deliver that power to said electrical accessory via said power input.

2. The monopod of claim 1, further comprising:
a charging port located in proximity to the proximal end of said body portion, said charging port configured to interface with a navigation light port of a marine vessel; and
wherein said battery power source is rechargeable and receives power through said charging port.

3. The monopod of claim 1, wherein said housing is waterproof.

4. The monopod of claim 1, further comprising:
a telescoping arm interposed between said body portion and said accessory base portion, said telescoping arm including a proximal end and a distal end, and wherein said telescoping arm proximal end is affixed to said body portion distal end, and said accessory base is affixed in proximity to said telescoping arm distal end.

5. The monopod of claim 4, further comprising an ergonomic handle interposed between said telescoping arm distal end and said accessory base.

6. The monopod of claim 4, further comprising:
said telescoping arm comprising at least a first arm portion and a second arm portion, wherein said first arm portion is configured to envelop said second arm portion; and
a locking element configured to lock said second arm portion in a telescoping position relative to said first arm portion.

7. The monopod of claim 6, further comprising:
a bendable arm pivotally connected to said telescoping arm, said bendable arm comprising at least two arm segments hinged at an elbow; and
said bendable arm comprising an interface configured to hold a second electrical accessory.

8. The monopod of claim 1, further comprising:
said body portion comprising at least one power port, said power port capable of providing electrical power to said portable accessory.

9. The monopod of claim 8, wherein said power port comprises a universal serial bus (USB) port.

10. The monopod of claim 1, wherein said accessory base comprises a mounting screw for interfacing with said housing, thereby securing said housing to said accessory base.

11. The monopod of claim 1, wherein said accessory base comprises a mounting screw for interfacing with said electrical accessory, thereby securing said accessory to said accessory base.

12. A monopod for interfacing with an electrical accessory, the monopod comprising:
a cylindrical elongated body portion having a proximal end and a distal end, said body portion including a battery power source;
a waterproof housing for containing said electrical accessory;
a wireless power receiver comprising a strip and a power input for interfacing with a charging port of said electrical accessory, said receiver placed within said housing;
an accessory base located in proximity to the distal end of said body portion;
a telescoping arm interposed between said body portion and said accessory base portion, said telescoping arm including a proximal end and a distal end, and wherein said telescoping arm proximal end is affixed to said body portion distal end, and said accessory base is affixed in proximity to said telescoping arm distal end;
said telescoping arm comprising at least a first arm portion and a second arm portion, wherein said first arm portion is configured to envelop said second arm portion;
a locking element configured to lock said second arm portion in a telescoping position relative to said first arm portion;
a wireless power transmitter located within said accessory base, said wireless power transmitter receiving power from said battery power source; and
said wireless power receiver configured to receive power from said wireless power transmitter and to deliver that power to said electrical accessory via said power input.

13. The monopod of claim 12, wherein said accessory base comprises a mounting screw for interfacing with said housing, thereby securing said housing to said accessory base.

14. The monopod of claim 12, further comprising:
said body portion comprising at least one power port, said power port capable of providing electrical power to said portable accessory.

15. The monopod of claim 14, wherein said power port comprises a universal serial bus (USB) port.

16. The monopod of claim 12, further comprising:
a charging port located in proximity to the proximal end of said body portion, said charging port configured to interface with a navigation light port of a marine vessel; and
wherein said battery power source is rechargeable and receives power through said charging port.

17. The monopod of claim 12 further comprising:
a bendable arm pivotally connected to said telescoping arm, said bendable arm comprising at least two arm segments hinged at an elbow; and
said bendable arm comprising an interface configured to hold a second electrical accessory.
